(19) United States
(12) Patent Application Publication
(10) Pub. No.: US 2004/0161546 A1
(43) Pub. Date: Aug. 19, 2004

(54) Method Of Making A Stone Veneer

(76) Inventor: Clay E. Clemmer, Tyler, TX (US)

Correspondence Address: THE LAW OFFICES OF H. DENNIS KELLY, 2401 TURTLE CREEK, DALLAS, TX, 75219, US

(21) Appl. No.: 10/707,935

(22) Filed: Jan. 26, 2004

Related U.S. Application Data
(63) Continuation-in-part of application No. 09/685,845, filed on Oct. 10, 2000, now abandoned.

(51) Int. Cl. B05D 1/12; B05D 1/36; B05D 5/00; B05D 3/02

(52) U.S. Cl. 427/407.1; 427/385.5; 427/180; 427/258; 427/243

(57) ABSTRACT

An artificial stone veneer product has a thin substrate covered by a stone veneer having a pitted, uneven surface having an appearance similar to travertine. To make the product, layers of polymer resin and particulate matter are applied to a substrate. A thin layer of polymer resin is first applied to the substrate, followed by a layer of fine particulate matter that at least partially settles into the resin, and the resin is allowed to set partially. Another layer of polymer resin is applied to the underlying layers in a nonuniform manner over the underlying layers, resulting in a moderately porous layer having randomly located voids of varying size and shape. A final layer of particulate matter is then applied over the polymer layer, and the resin is allowed to set completely. In an optional step, the surface of the final product is finished to smooth it, during which some of the larger particulate matter is dislodged and removed, enhancing the uneven rough appearance of the veneer.

### CROSS REFERENCE TO RELATED APPLICATIONS

This application is a continuation in part of application Ser. No. 09/685,845, filed Oct. 10, 2000 now abandoned.

### BACKGROUND OF INVENTION

The invention relates to manufactured building materials, and in particular to a method for making a moderately porous stone veneer that gives an aesthetic appearance reminiscent of travertine and similar naturally occurring stone.

Stone veneers are popular for walls and counter tops, and many methods have been devised for producing both natural and artificial stone veneers. Recently, travertine has gained more popularity, due in part to its uneven, pitted surface that provides an aesthetically pleasing texture to a normally smooth stone surface. However, the prior art has traditionally sought to provide a natural or artificial stone veneer having either a smooth surface or a roughened surface consisting of protrusions extending from a smooth base (e.g. rough brick or pebbled surfaces). Also, prior art methods generally create a relatively thick, heavy veneer that requires a sturdy backing for support.

U.S. Pat. No. 3,950,202, issued to Hodges, illustrates an early method of obtaining thinner stone veneers. A slab of natural stone thick enough to be handled without breaking has a support substrate adhesively attached to both faces. The stone is then cut widthwise through the slab, from one edge to the opposite edge parallel to the faces, resulting in two stone slabs supported by a substrate. The resulting slabs are too thin to support themselves or to be handled without breaking. The faces of the resulting slabs generally require considerable finishing, since the cutting step tends to leave a rough, irregular surface. While this method does achieve a thin veneer that wastes less material than prior methods, it still wastes a significant amount of material, both in making the cut through the original slab and in finishing the resulting slabs to give an acceptably smooth surface.

U.S. Pat. No. 4,466,937, issued to Johnston et al., discloses several methods for making Venetian mosaic or terrazzo surfaces. In one method, a flat support is covered with a membrane and the upper surface of the membrane is coated with a releasable adhesive. Stones are laid on the membrane, and separators are placed around the membrane to mark off the product to be produced. Concrete or other casting material is poured into the marked off area and allowed to set. Steps for creating a design or pattern in different colors from the main part of the product are disclosed. In another embodiment, the stones are placed into a mold having an nonplanar surface, such as for a bas relief. In every embodiment of the invention, the bottom of the mold forms the surface of the finished product. Thus, this method cannot be used to cover the surface of a manufactured article.

U.S. Pat. No. 4,624,815, issued to Moufarrege, discloses another method for making stone mosaic products. This method discloses the use of polyester resin for filling and casting. The surface stones are still placed manually into the bottom of a mold.

U.S. Pat. No. 5,813,183, issued to Attley, discloses a method for making tiles resembling ceramic, slate, stone, cement, or terra cotta.

U.S. Pat. No. 5,942,072, issued to McKinnon, discloses a method of making a decorative resilient floor covering. A layer of curable polymer, specifically a polyurethane, is applied to a substrate, after which a layer of pigmented particulate matter, preferably paint chips, is blown upward so that it falls over the polymer, and the polymer is cured. Tape is then applied over the cured polymer/particulate structure in a decorative pattern, and a second layer of polymer is applied, along with a second layer of pigmented particulate material. The tape is removed, and a third layer of polymer and particulate are applied. Since the process is used to produce floor covering, patterns such as the voids present in travertine that would trap dirt and foreign particles are undesirable.

Prior art methods have several disadvantages. In general, the methods produce a relatively thick, heavy product. A veneer cannot be applied on top of a substrate with an irregular surface, but must essentially be created in a mold, with the substrate being pressed into the veneer as it forms. Since the prior art methods are directed to making products intended to shed water and foreign matter, they avoid surfaces having holes, pits, or similar voids that would trap water. Thus, a surface having the appearance of travertine would be considered undesirable in the prior art. Also, the prior art products are permanently formed when manufactured, and cannot be reshaped.

### SUMMARY OF INVENTION

The term “moderately porous” is defined as having a substantially smooth face defining a number of randomly located voids of varying size and shape and making up at least about ten percent of the total surface area of the face. The voids preferably make up about thirty to thirty-five percent of the total area. The voids are greater in number and generally larger than those occurring in veneers having smooth facing.

In the preferred embodiment a thin, relatively rigid substrate is optionally prepared, which can include the steps of roughening the substrate to accept a veneer and securing the substrate in place. This step is followed by applying a thin layer of polymer resin onto the prepared surface of the substrate, then applying a first layer of particulate matter on the polymer layer and allowing the resin to set partially. Usually, the particulate matter tends to penetrate into the polymer layer at least partially. A second layer of polymer resin is then applied in a manner that only partially covers the underlying layers, then a second layer of particulate matter is applied to the second layer of polymer resin and the resin is allowed to set. Both thermoplastic and thermosetting materials can be selected for use as the polymer resin. This embodiment can be adapted for use with substrates having a curved or irregular surface. One example for which the method of the invention is well suited is the production of face plates for electrical power outlets and switches. These face plates can then be made to match the stone veneer of the underlying paneling.

HTML1DocumentEncodingutf-8ln another embodiment, a veneer is made on a flexible thin substrate. The substrate is secured under tension on a support surface, which can be planar or convex. The substrate is covered with the resin and particulate layers as in the primary embodiment, and allowed to set completely. The finished product can be applied as formed. If a thermoplastic resin is used, the product can be repeatably reshaped over a surface by applying radiant or convective heat to soften the polymer resin.

In yet another embodiment, the immediately preceding embodiment can be modified by the use of a substrate that can be easily removed from the formed veneer, so that the veneer can be applied directly to an existing uncovered substrate by conventional means such as adhesive.

HTML1DocumentEncodingutf-8ln a final embodiment, a veneer is formed by bubbling a gas, usually air, through the layers of polymer resin and particulate matter during setting. The method can be practiced by applying the polymer layers to a substrate, or can be formed as a slab by laying down successive layers of polymer and particulate matter. The veneer can be made in thicknesses of up to about four feet (1.25 meters) thick, and cut into individual slabs in a manner similar to the Hodges method.

Further advantages and features of the invention will be apparent to someone of ordinary skill in the art, and will become apparent from the following discussion.

### BRIEF DESCRIPTION OF DRAWINGS

FIG. 1 is a perspective view of a thin panel substrate secured in place prior to application of a stone veneer.

FIG. 2 is a cross-sectional side view of the panel of FIG. 1 after the stone veneer is applied, showing the individual layers of the veneer.

FIG. 3 is a perspective view of an alternative apparatus, showing electrical faceplates as substrates, just prior to their installation on a supporting surface.

FIG. 4 is a perspective view of the embodiment of FIG. 3, showing the support surface covered with faceplates.

FIG. 5 is a perspective cutaway view of the apparatus of another method, showing a flexible substrate secured to a support surface.

FIG. 6 is a front elevation of a preferred method of finishing the surface of a veneer.

FIG. 7 is a perspective view of a thin panel during the production of a veneer having an inlay.

FIG. 8 is a perspective view of a thin panel after the production of the first part of a veneer having an inlay.

FIG. 9 is a perspective cross-section of an alternative apparatus having means for bubbling gas through the veneer layers in accordance with an alternative method of the invention.

### DETAILED DESCRIPTION

The basic method for making a conventional panel will be described first, followed by alternative method embodiments for making various types of stone veneer products. The same basic steps are used throughout the various embodiments. Elements of the apparatus having similar functions are given the same reference numbers throughout the drawings, which are not necessarily drawn to scale.

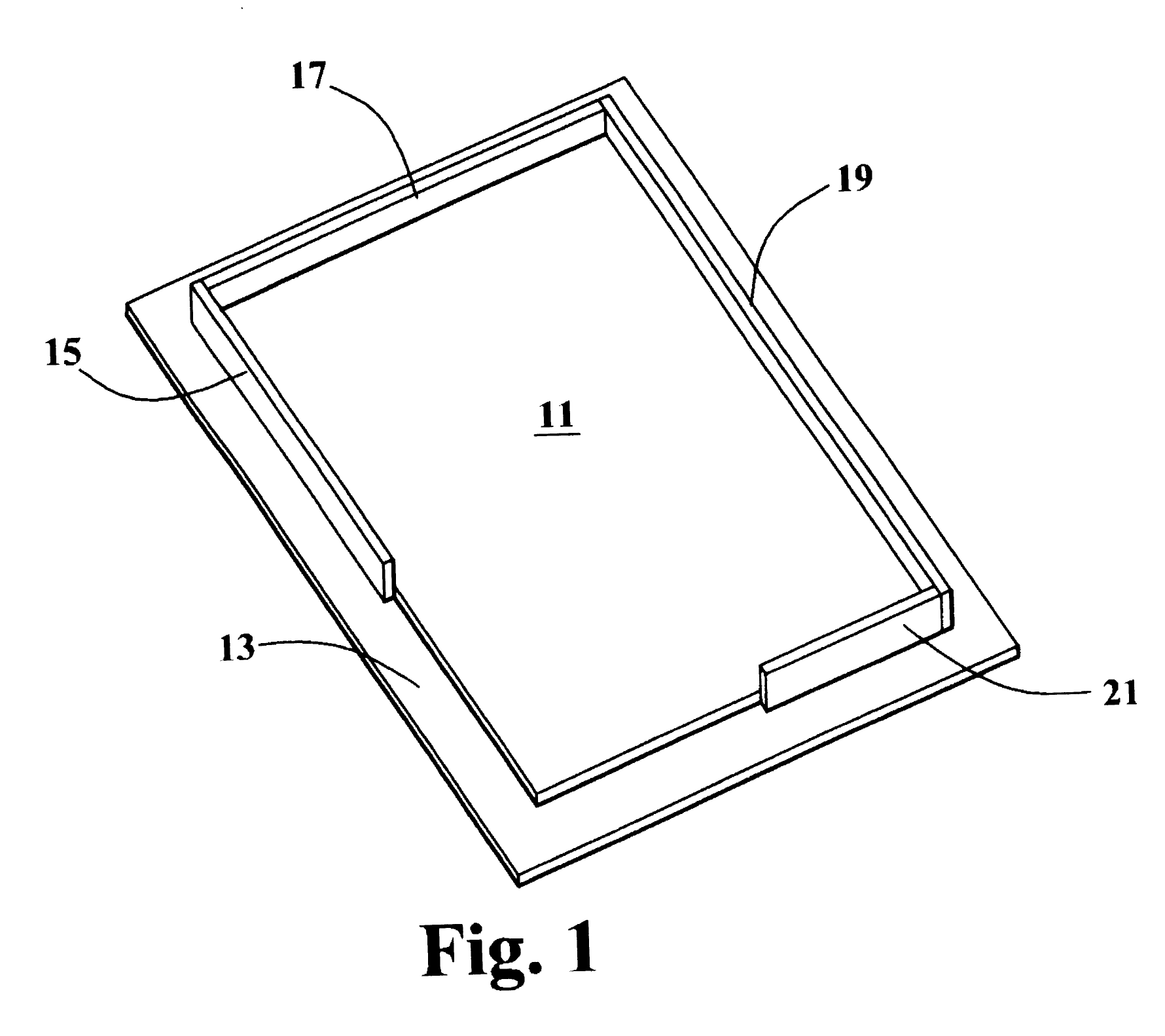

The optional first step of the method as shown in FIG. 1 comprises preparing a substrate, in this case a thin, rigid panel 11, for being covered by a veneer. The panel 11 can be any paneling material known in the art, including but not limited to wood, metal sheet and plastic. In some cases, preparation may require treating the surface so that it will bond firmly with a polymer resin. Example treatments include mechanically roughening the surface and chemically treating it with cleaners or etchants. The prepared panel 11 is placed upon a support surface 13 and secured in place with braces 15, 17, 19, and 21. The support surface 13 is preferably a glass sheet bonded to a supporting base. In this case, the braces 15, 17, 19, and 21 also form upright walls to help contain the layers that will be applied in the following steps.

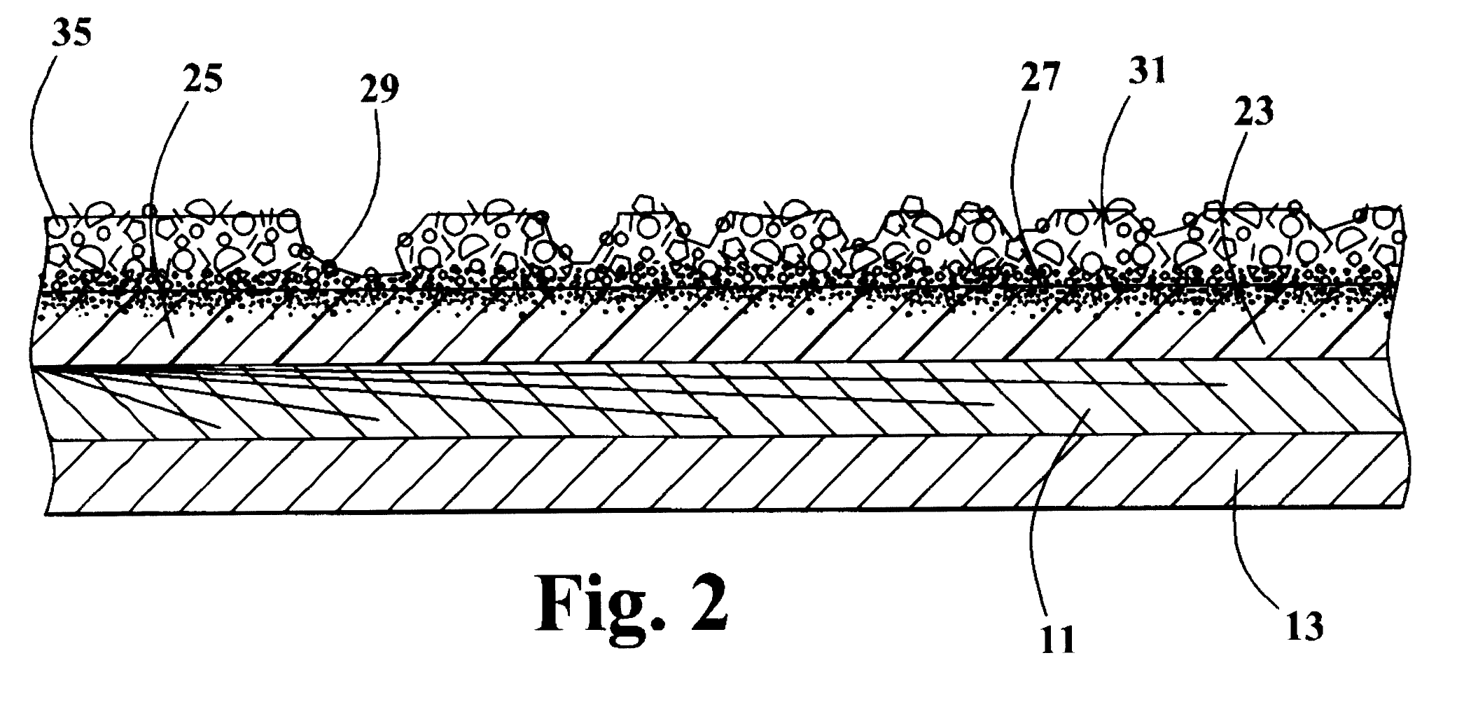

In the following steps, numerous layers of material are applied to the panel 11. FIG. 2 shows the various layers in cross-section, as they typically appear in the finished product.

In the next step, a polymer resin 23 is applied to the panel 11, forming a thin resin layer 25 on top of the panel. The layer can be applied by any method known in the art, including but not limited to pouring, brushing or spraying the resin manually or by automated machinery. Thermoplastic resins such as polyester or thermosetting resins such as epoxy can be used. A “flowing” polyester resin in a solvent base, with viscosity and flowing properties similar to pancake batter, has been successfully used to practice the method. The preferred polyester resin is mixed with a benzoyl peroxide hardening agent just prior to application, and typically hardens into a soft solid in approximately ten minutes. The resin layer is about one thirty-second of an inch (0.8 mm) thick, although the thickness can be varied above or below this value to suit a particular purpose. The resin can be tinted to match the desired surface color, but this is not necessary, as will become apparent in the following discussion. The resin layer 25 is allowed to set for a predetermined time, so that the layer will partially set. The term “set” describes the transformation of the resin from a flowing fluid to a solid, regardless of the actual mechanism, that is, whether by evaporation of a solvent base, a chemical reaction such as the curing of epoxy resins or the use of hardening agents, or some other mechanism.

In the next step, particulate matter 27 is poured onto the first resin layer 25 to form a particulate layer 29. The particulate matter 27 can be made of stone (including but not limited to granite, limestone, quart, marble, and slate), metal (in the form of flakes, filings, or dust), sand, or synthetic materials such as plastic chips. It should therefore be appreciated that the term “stone veneer” as used herein means not only veneers simulating a natural stone appearance by the use of particulate stone, but veneers using the aforementioned non-stone particulate matter as well. The particles in this layer preferably are all smaller than about one-sixteenth inch (1.6 millimeters) maximum dimension, and are most preferably the size of dust or sand. This layer 29 is intended to cover the underlying resin layer and give the final product its desired color. The poured particulate material may require the additional step of being gently graded to give a fairly uniform thickness across the layer 29.

The particulate layer 29 is typically about one-sixteenth inch (1.6 millimeters) thick, but the thickness can be varied. Although the particulate layer 29 is preferably about twice the thickness of the resin layer 25, the thickness of the particulate layer relative to the resin layer can be varied substantially. The particulate layer needs only be at least the same thickness as the resin layer, and should be thin enough to allow it to be properly covered by a subsequent resin layer. The particulate matter layer 29 will naturally tend to sink into the partially cured first resin layer 25 and intermix to some degree. This is desirable to an extent.

The first resin layer 25 should be allowed to set partially before proceeding to the following step. Depending on the selection of materials, the resin layer may naturally set sufficiently during the application of the particulate matter layer 29 so that no additional waiting time is required.

In the following step, a final layer 31 of polymer resin is laid down over the particulate matter layer 29. This final resin layer 31 is typically about one-sixteenth inch (1.6 millimeters) thick, but the thickness can be varied. Unlike the first resin layer 25, the final resin layer 31 is nonuniformly applied so as to leave gaps in the layer, preferably extending completely through the layer, leaving the underlying particulate matter exposed. The final resin layer 31 has been poured manually, and is preferred for small production runs, since it is cheaper and easier to set up, and produces veneers with an individualized appearance. For large production runs, any manufacturing method presently practiced for applying resin in a predetermined pattern can be used, preferably by using CNC (computer numerical control) machinery dispensing resin from one or more dispensing nozzles. While applying the resin, various methods can be used to achieve an irregularly pitted surface. Examples include applying the resin in straight or curved paths with varying distances between adjacent paths, or interrupting the flow of resin from the nozzles as the nozzles are moved through their preset paths.

Following the step of applying the final resin layer 31, a final layer 35 of particulate matter is applied over the final resin layer 31. The particulate matter making up this final particulate layer 33 is generally larger than that of the first particulate layer 29, with about half of the material having a maximum dimension between about one-sixteenth inch (1.6 mm) and about one-fourth inch (6.35 mm), and about half having a maximum dimension less than about one-sixteenth inch (1.6 mm) but still significantly larger than the dust-like particulate matter in the first particulate layer 29. The resin layers 21 and 31 are then allowed to set completely. The braces 15, 17, 19 and 21 can be taken off, and the finished product removed from the support surface 13 once the resin has completely set sufficiently to allow handling, but it is preferred that the resin set more or less completely before moving the finished product.

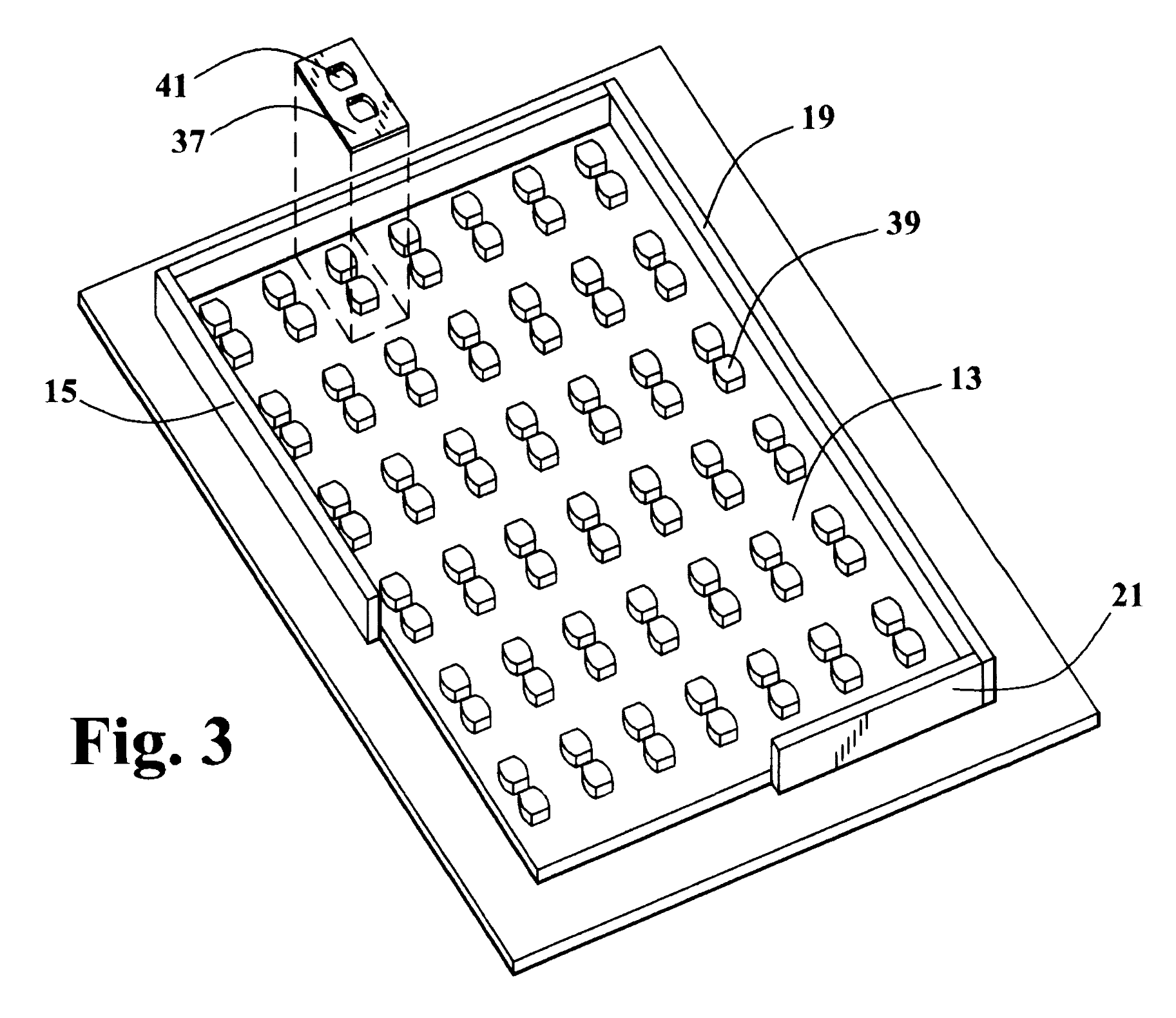

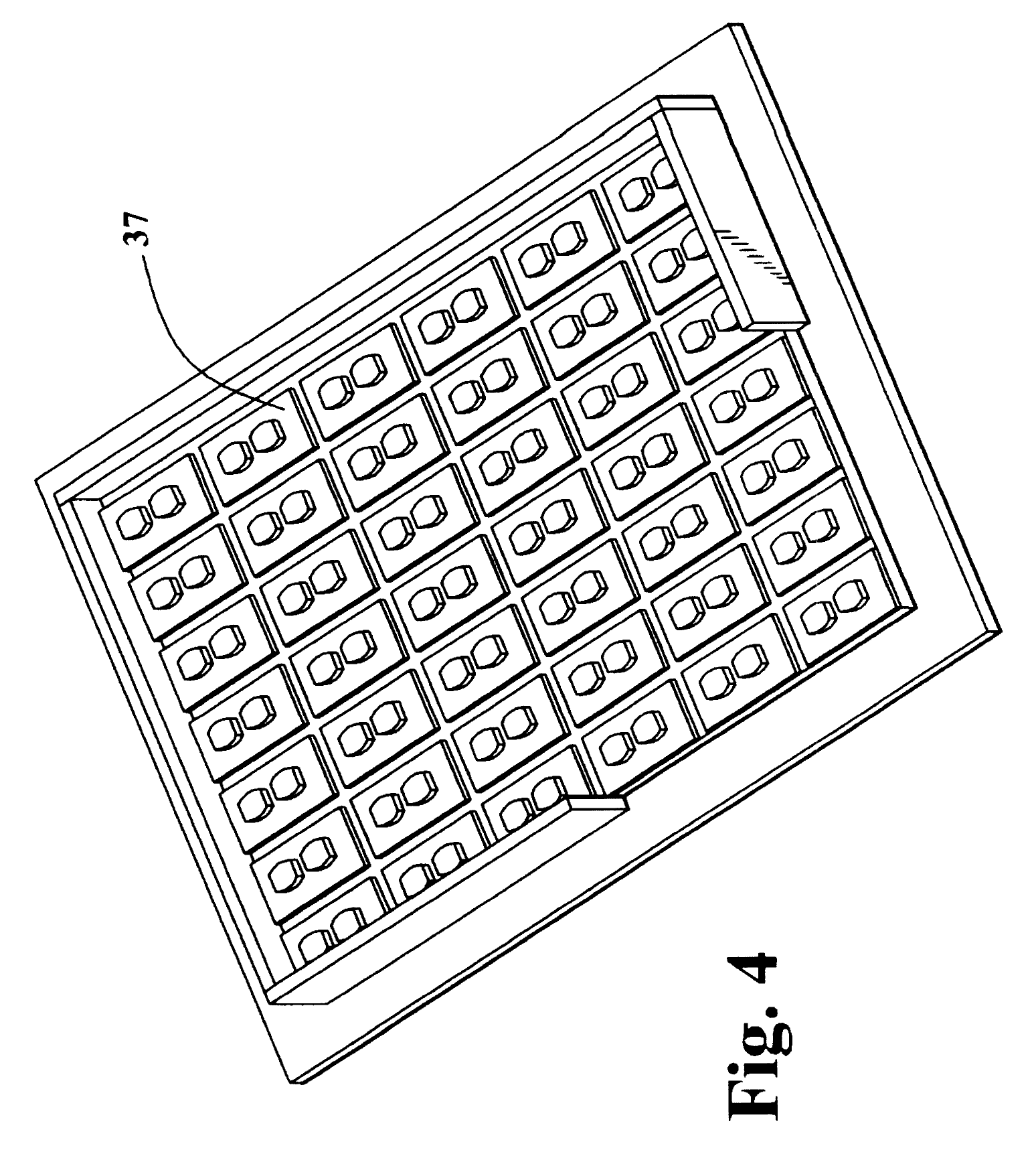

The method described above can be adapted for covering substrates having a curved or irregular surface. FIGS. 3 and 4 show one example, in which the method is used to apply a veneer to an number of identical electrical faceplates 37. Elements performing the same function as the previous embodiment are referenced with the same references numbers, and only the differences from the previous embodiment will be discussed. An array of rubber plugs 39 are adhesively attached to a glass support surface 13, with the plugs 39 sized and arranged to mate with holes 41 in the faceplate 37. The support surface 13 can thus hold an array of faceplates 37 so that a large number of veneered faceplates can be produced simultaneously. The finished faceplates are separated by cutting them apart with a saw. Individual faceplates 37 are spaced apart from adjacent faceplates on the support surface 13 by a distance roughly equal to the sum of two veneer thicknesses plus the width of the saw cut made to separate the individual faceplates. Similarly, the faceplates 37 on the outer edges of the array are separated from their respective adjacent braces 15, 17, 19, and 21 by roughly the thickness of the veneer, or slightly thicker to permit some finishing of the veneer. The support surface 13 is preferably coated with a thin layer of a release agent so that the polymer resin around the edges of the faceplates won't adhere to the support surface.

The substrate need not be rigid, but can be made of flexible fabric or other flexible thin material. The product of this embodiment has a feature not present in products of known methods: the product can be reshaped during installation by convective or radiant heating. In this embodiment, thermoplastic polymers must be used, since thermosetting plastics by definition cannot be made soft and moldable by heating. In an alternative embodiment for making such a veneered product, the substrate is a made of a material that can be removed from the veneer after the polymer resin layers have completely set. No product having this structure and features is known to be produced at this time, so the method would be applicable to making veneers having a smooth, unpitted surface as well as the irregular, pitted veneers described previously.

The substrate is preferably made of fabric such as canvas. The use of fabric lends some strength to the resulting product, while still allowing the final product to be reshaped. However, the veneer can even be produced with a removable substrate, such as waxed paper or a releasable plastic sheet. The product can then be applied directly to a preexisting, non-veneered surface by adhesive or other known methods. This type of product is preferably produced in smaller pieces that will not be too fragile for normal handling.

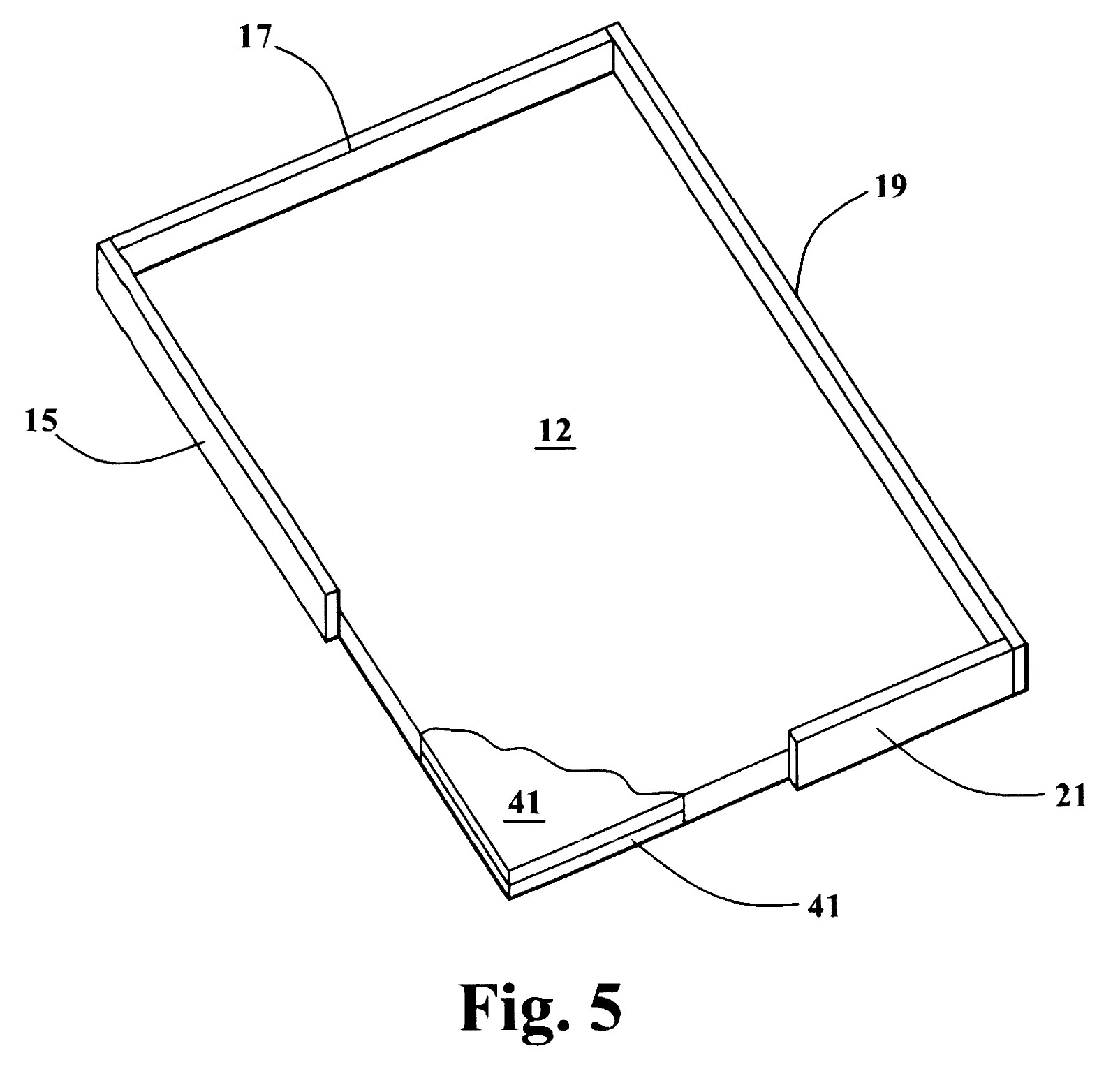

FIG. 5 illustrates a preferred arrangement for putting a veneer on a piece of canvas. In the first step, the canvas is secured to a support surface 41 with a frame 43 in a manner similar to mounting a canvas for a painting. The rest of the method is identical to the method shown in part in FIG. 1.

While this embodiment of the method is shown being performed using a planar support surface, the use of a flexible substrate permits almost any convex shape for the support surface, resulting in greater flexibility in the overall shape of the product. For example, the support surface can be shaped like a spherical section or other curved surface, even including a cylinder. Another possible configuration is a polyhedral shape, such as might be used for the base or pedestal of a pillar. Thus, the method can be used to produce a stone veneer to cover the various parts of a column made of an inexpensive material such as wood or concrete. The parts would then be assembled to create an artificial stone column.

In some cases, a thicker veneer or a veneer with even deeper pitting and texture is desired. Additional layers of resin and particulate matter can be applied, preferably in pairs of resin and particulate matter as previously described. The additional layers can be either continuous, like the first resin and particulate layer pair, or have gaps like the final resin and particulate layer pair. When layers having gaps are added, it is preferable that the gap pattern substantially match the pattern for the final resin layer, but some variation between the gap patters can produce interesting results. The step of applying additional layers can be used in all of the method embodiments.

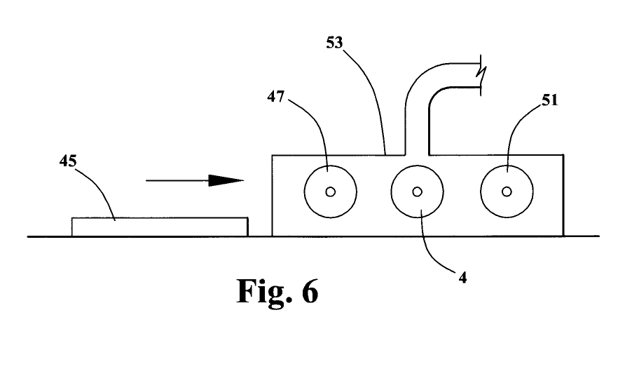

For all of the methods already discussed, additional finishing steps can be performed to finish the surface of the product after the last applied resin layer has set. First, a mechanical finishing step can be performed, wherein the top surface of the finished product is smoothed by abrasion, such as by rubbing sandpaper across the surface. FIG. 6 shows a preferred method of finishing the surface. The veneer product 45 is passed under a series of grinding wheels 47, 49, and 51 inside a vented hood 53. The wheels 47, 49, and 51 preferably have progressively finer abrasive surfaces. The product can be honed to a fine polish, or left slightly rough for a more natural appearance, as desired. This step also allows the thickness of the veneer to be closely controlled, and the wheels 47, 49, and 51 can be given nonplanar contours in order to sculpt the veneer for artistic and aesthetic effects, such as grooving, waves, etc. Care must be taken not to remove too much of the veneer, lest the desired surface texture (i.e. the voids created by the final resin layer) be removed. However, light finishing will generally enhance this texturing, especially as the product passes under the first wheel 47. This is because some of the larger particulate matter in the final particulate layer 35 tends to be dislodged from the product during finishing, resulting in pitting having irregular surfacing that can add to the product's aesthetics. Following the mechanical finishing step, a sealing step can be performed, wherein a thin layer of sealer is applied to the veneer to help preserve the surface.

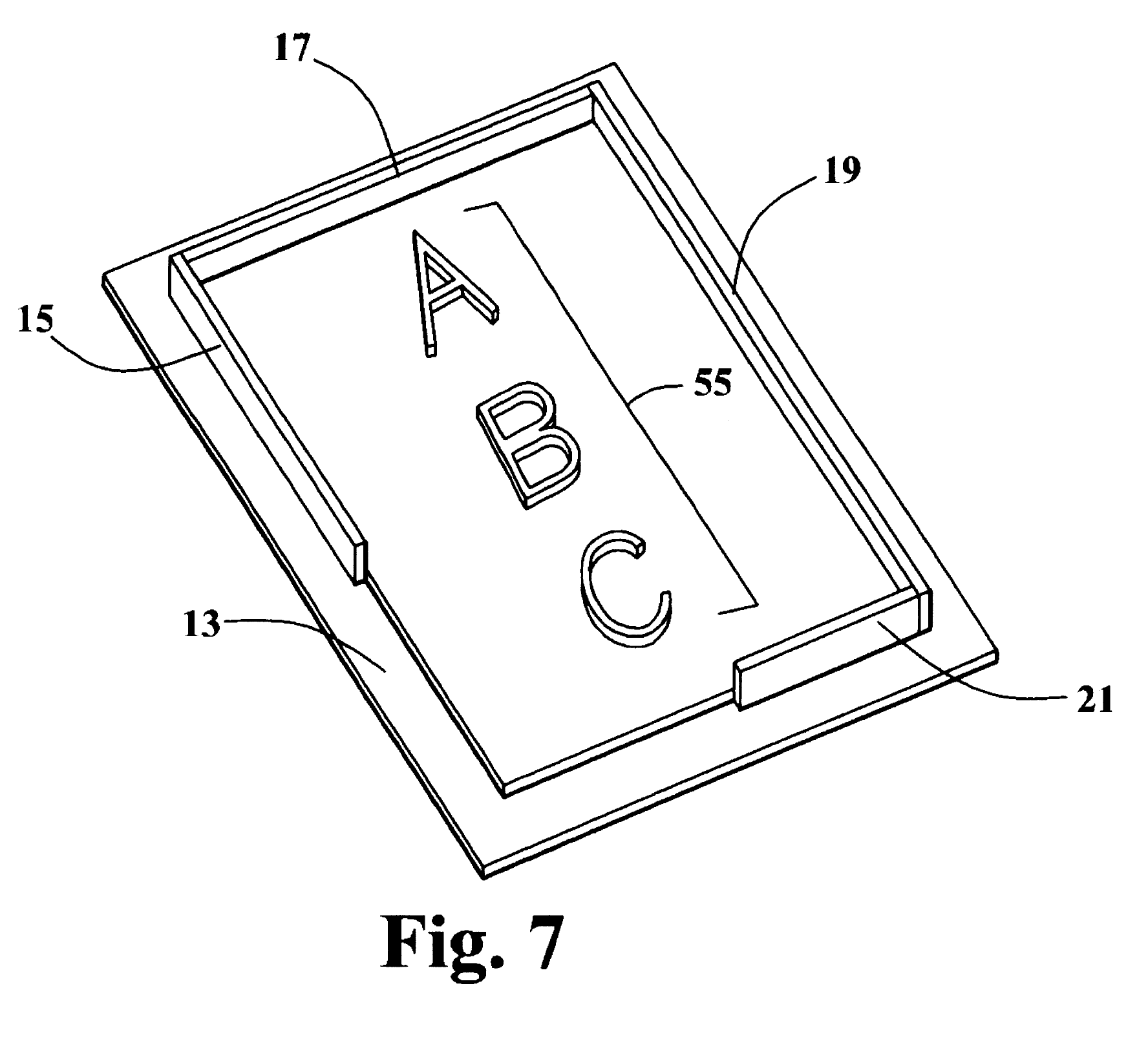

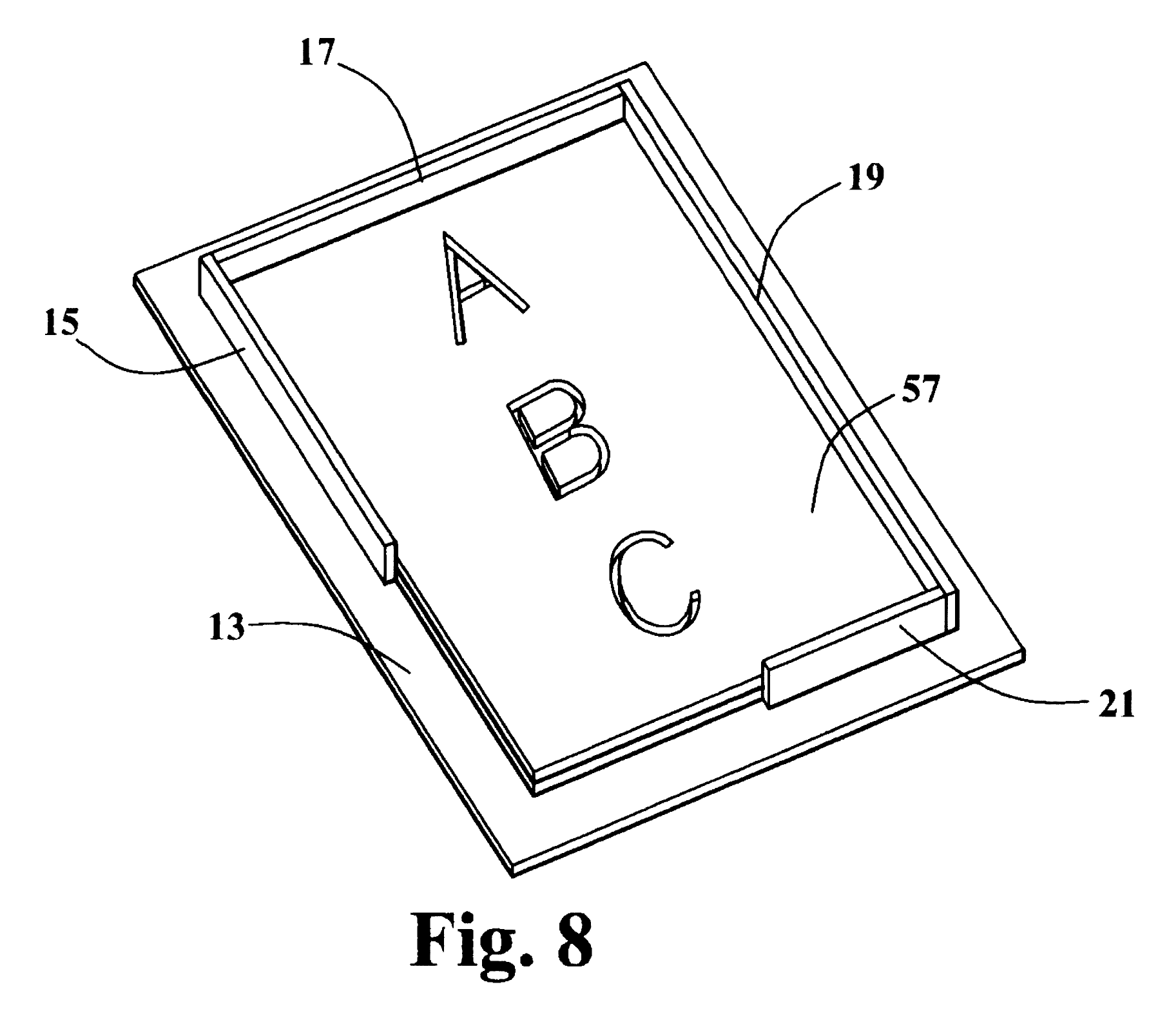

A design, pattern or artwork can be formed in the veneer in any of the methods already discussed. This allows the use of the various embodiments of the method to be used for making products that imitate two-toned or other multi-colored stone, such as lapis lazuli or marble. As an example FIG. 7 illustrates the beginning steps of this embodiment for use on the thin panel of FIG. 1. The panel 11 is prepared just as in FIG. 1. Then a stencil 55 made of rubber or other releasable material having the thickness of the final veneer is placed on the panel 11, and a veneer is produced as previously described. Either the inlay portion or the background can be covered first, depending on how the stencil 55 is made. The stencil 55 is covered over by the final layers during production of the veneer. The mechanical finishing step is then performed on the veneer to grind it down to the top surface of the stencil 55, and the stencil 55 is removed, leaving a partially covered panel as shown in FIG. 8. The top surface 57 of the first veneer is then taped over, and the process is repeated for a second veneer that will contrast with the first veneer. The entire product is then finished and sealed as desired. This method can be expanded for more than two contrasting veneers, by using more than one stencil as needed.

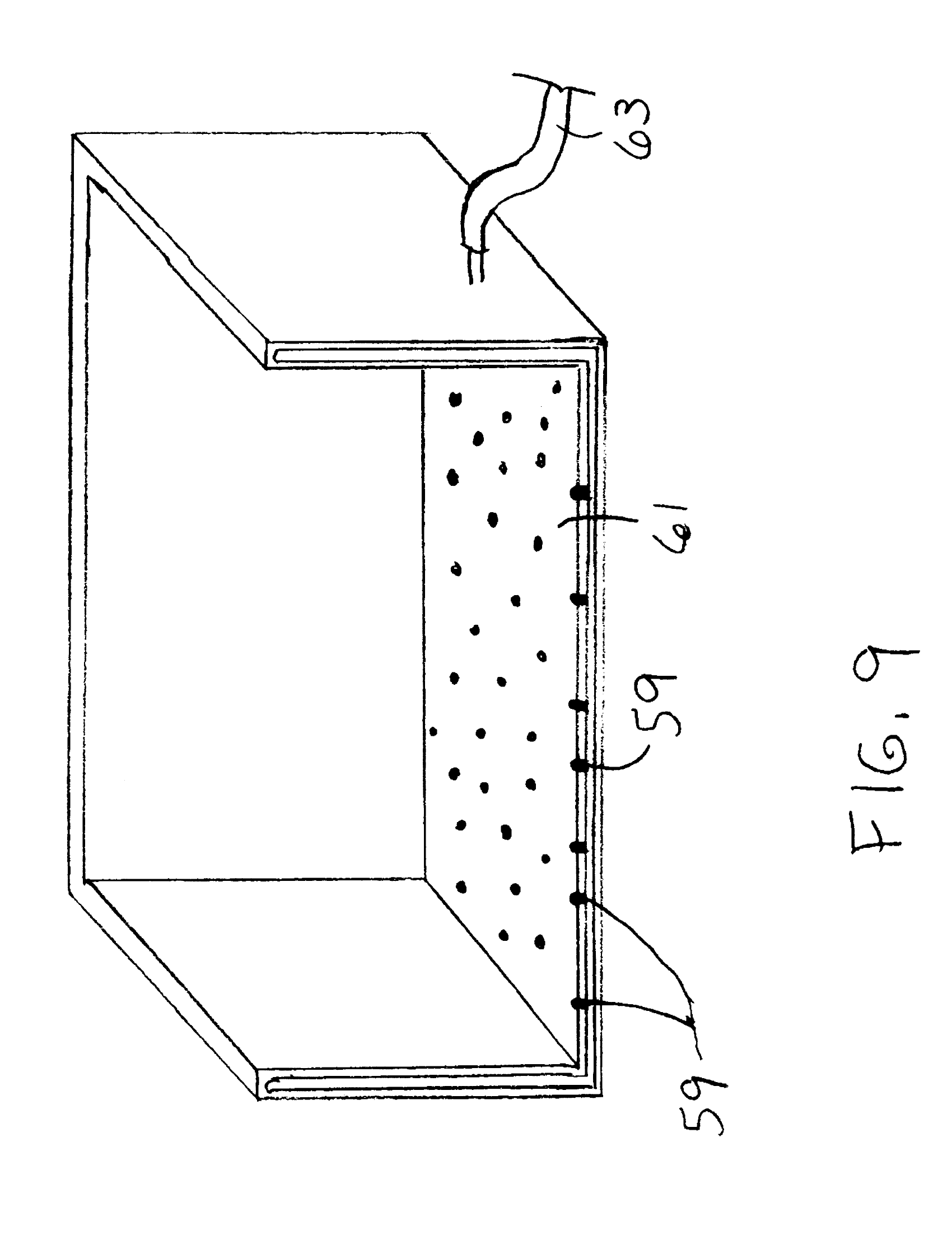

Finally, another embodiment is envisioned that creates a moderately porous stone veneer having the additional step of bubbling a gas, usually air, through the resin layers during setting. One possible apparatus for performing such a step is shown in FIG. 9, which in general is an integral hollow shell with connections for supplying a gas under pressure to the interior of the hollow shell. A number of small orifices 59 are formed in the floor 61 (which acts as the support substrate 13) and fed by a supply 63 of compressed air, preferably at about five to ten pounds per square inch gauge pressure (34.5 to 69 kPa). The orifices 59 are arranged in an apparently random pattern, and preferably vary in diameter to produce voids of varying size. Orifice diameters of about one-eighth to one-quarter inch (3.18 to 6.35 millimeters) are preferred. The air supply should be supplied through a check valve to prevent flow of the resin into the orifices in case of supply failure. Obviously, the substrate on which the polymer and particulate layers are applied should have holes passing through the substrate and located to aligns with corresponding orifices in the floor 61. The use of bubbling gas generally results in more pronounced voids throughout the layers than in previous methods, where the resin tends to flow before become fully set, which tends to fill in the voids formed during application of the resin. These more pronounced voids give a more desirable appearance to the finish product, which is also thicker for the same amount of resin used in the previous embodiments. In addition, the bubbling can cause internal circulation of the resin, which also results in an improved aesthetic appearance due to better distribution of the particulate matter and optional pigments in the polymer resin.

This embodiment can also be used to create blocks (up to four feet (1.25 meters) thick). In this case, it is preferred that the walls 61 also have orifices. The blocks can then be sliced into thinner slabs. However, the resulting synthetic stone veneer has better strength and resilience than natural travertine, and is less susceptible to breakage during handling.

The invention has been described in several embodiments. It should be apparent to someone skilled in the art that the invention is not limited to these embodiments, but is capable of being varied and modified without departing from the scope of the invention as set out in the attached claims.

1. A method of making a moderately porous stone veneer product comprising the steps of: a) applying a first layer of polymer resin to a substrate; b) applying a layer of particulate matter to the first polymer resin layer and allowing the polymer resin to set partially; d) applying a final layer of polymer resin in a nonuniform manner on top of the first polymer resin layer and the particulate matter layer, thereby creating a moderately porous final layer; and e) applying a final layer of particulate matter into the final layer of polymer resin and allowing the polymer resin to set. 2. The method of making a moderately porous stone veneer product of claim 1 further comprising the step, occurring before step (a), of preparing the substrate to receive the first layer of polymer resin.

2. The method of making a moderately porous stone veneer product of claim 1 further comprising the step, occurring before step (a), of preparing the substrate to receive the first layer of polymer resin.

3. The method of making a moderately porous stone veneer product of claim 1 further comprising the step, following step (e), of finishing the surface of the product, wherein pieces of particulate matter in the final layer of particulate matter are removed during the finishing step to increase the number of voids defined in the surface of the product.

4. The method of making a moderately porous stone veneer product recited in claim 3 further comprising the step, occurring after the finishing step, of applying a sealer to the finished surface.

5. The method of making a moderately porous stone veneer product recited in claim 1 further comprising the step, occurring between steps (c) and (d), of applying at least one additional polymer resin layer and one additional particulate layer.

6. A method of making a repeatably reformable moderately porous stone veneer product having a flexible substrate covered with an artificial stone veneer, comprising the steps of: a) securing a flexible substrate to a support surface for receiving the veneer; b) covering the substrate with a first layer of polymer resin; c) applying a layer of particulate matter into the first polymer resin layer and allowing the polymer resin to set partially; d) applying a final layer of polymer resin on top of the first polymer resin layer and the particulate matter layer in a nonuniform manner on top of the underlying layers, thereby creating a moderately porous final layer; and e) applying a final layer of particulate matter into the final layer of polymer resin and allowing the polymer resin to set.

7. A method of making a stone veneer product as recited in claim 6 further comprising the step, following step (e), of finishing the surface of the stone veneer product.

8. The method of making a stone veneer product recited in claim 7 further comprising the step, occurring after the finishing step, of applying a sealer to the finished surface.

9. The method of making a stone veneer product recited in claim 6 further comprising the step, occurring between steps (c) and (d), of applying at least one additional polymer resin layer and one additional particulate layer.

10. A method of making a moderately porous stone veneer product comprising the steps of: a) applying a first layer of polymer resin to a substrate; b) applying a layer of particulate matter to the first polymer resin layer and allowing the polymer resin to set partially while bubbling a gas through the resin layer; d) applying a final layer of polymer resin in a nonuniform manner on top of the first polymer resin layer and the particulate matter layer, thereby creating a moderately porous final layer; and e) applying a final layer of particulate matter into the final layer of polymer resin and allowing the polymer resin to set while bubbling a gas through the layers.

11. The method of making a moderately porous stone veneer product of claim 10 further comprising the step, occurring during steps (a) and (d), of bubbling a gas through the applied layers.

12. The method of making a moderately porous stone veneer product of claim 10 further comprising the step, following step (e), of finishing the surface of the product, wherein pieces of particulate matter in the final layer of particulate matter are removed during the finishing step to increase the number of voids defined in the surface of the product.

13. The method of making a moderately porous stone veneer product recited in claim 12 further comprising the step, occurring after the finishing step, of applying a sealer to the finished surface.

14. The method of making a moderately porous stone veneer product recited in claim 10 further comprising the step, occurring between steps (c) and (d), of applying at least one additional polymer resin layer and one additional particulate layer.
